(19) United States
(12) Patent Application Publication
(10) Pub. No.: US 2009/0167990 A1
(43) Pub. Date: Jul. 2, 2009

(54) Liquid Crystal Display Appliance

(76) Inventors: Akitoyo Konno, Hitachi (JP); Yoshifumi Sekiguchi, Hitachiota (JP); Ikuo Hiyama, Hitachinaka (JP); Hiroshi Sasaki, Mito (JP); Yokohama Taniguchi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/344,680

(22) Filed: Dec. 29, 2008

(30) Foreign Application Priority Data
Dec. 28, 2007 (JP) 2007-339529

(51) Int. Cl. G02F 1/13357; G09G 3/36

(52) U.S. Cl. 349/65; 345/102

(57) ABSTRACT

An object of the present invention is to provide a liquid crystal display appliance for controlling a plurality of divided area in the display screen. In order to achieve the above object, the liquid crystal display appliance according to the present invention includes a lighting apparatus which includes a light source, and an light guide plate to diffuse lights from the light source to obtain a surface light source; and a liquid crystal panel which is placed opposed to the lighting apparatus and includes a liquid crystal layer. The light guide plate is made by bonding a plurality of transparent light guide members each of which has a different refractive index greater than 1.

### CROSS REFERENCE TO RELATED APPLICATIONS

The present application claims benefit of the filing date of Japanese Patent Application No. 2007-339529 filed on Dec. 28, 2007, the disclosure of which is incorporated herein by reference.

### FIELD OF THE INVENTION

The present invention relates to a liquid crystal display appliance used in a television, and a cellular phone, etc.

### DESCRIPTION OF THE RELATED ART

In recent years, as compared with a prior art cathode-ray tube display, a liquid crystal display appliance widely used in a television, and a cellular phone, etc. has an advantage of being thin-shaped as a flat-panel display.

In order to utilize this advantage, the liquid crystal display appliance employs a side light type liquid crystal display instead of a prior art direct back light type liquid crystal display. In the prior art direct back light type liquid crystal display, lights from a light source are allowed to pass through a voltage-controlled liquid crystal panel from its backward, and the light source is provided behind a display screen G (see FIG. 13A). In contrast, in the side light type liquid crystal display of a liquid crystal display television 100 as shown in FIG. 13A, light sources k are placed on both sides of the display screen G so that lights from the light sources k are diffusely reflected, and the reflected lights are guided from backward of a liquid crystal panel 101 as a surface light using an light guide plate 102 (see FIGS. 13B and 13C).

In addition, FIG. 13A is a front view of the prior art liquid crystal display television 100, and FIGS. 13B and 13C are conceptual diagrams showing structures of the light guide plate 102 and the light source k in the prior art liquid crystal display television 100.

Meanwhile, the liquid crystal display television 100 shown in FIG. 13A employs an area control system in which the display screen G is longitudinally divided into a plurality of areas r, the light source k and the light guide plate 102 are provided for every area r and are controlled, and a brightness of each area r is adjusted to improve a contrast in accordance with an image data of each area r and to improve the drawing performance of the liquid crystal display television 100.

For example, JP 2006-134748 A discloses a technique for dividing the light guide plate 102 and the light source K.

Meanwhile, as shown in FIG. 13B, when the light guide plate 102 is formed as a single-piece, it becomes difficult to adjust the brightness of any area r of the liquid crystal panel 101 (see FIG. 13A) because lights from the light source k diffuse too wide in the light guide plate 102 (i.e., in the display screen G) to be modulated effectively (see arrow α102).

On the other hand, as shown in FIG. 13C, JP 2006-134748 A discloses that little or no light leaks into the adjacent light guide plate 102 via an air layer a1 between the light guide plates 102 because the light guide plate 102 is divided, and lights traveling in the light guide plate 102 are almost totally reflected at the surface of the light guide plate 102 owing to difference in refractive index between the light guide plate 102 and the air layer a1 (see arrow α101 in FIG. 13C). For this reason, the lights from the light source k do not diffuse in the display screen G (see FIG. 13A). As a result, a problem arises that modulation is effect for every area r, but variations in characteristic of each light source k is observed as change in brightness and color for every area r.

In view of the foregoing, an object of the present invention is to provide a liquid crystal display appliance for well controlling a plurality of divided area in the display screen.

### SUMMARY OF THE INVENTION

In order to achieve the above object, the liquid crystal display appliance according to the present invention includes a lighting apparatus which includes a light source, and an light guide plate to diffuse lights from the light source to obtain a surface light source; and a liquid crystal panel which is placed opposed to the lighting apparatus and includes a liquid crystal layer. The light guide plate is made by bonding a plurality of transparent light guide members each of which has a different refractive index greater than 1.

According to the present invention, the liquid crystal display appliance for well controlling a plurality of divided area in the display screen can be obtained.

### BRIEF DESCRIPTION OF THE DRAWINGS

The objects and features of the present invention will become more readily apparent from the following detailed description taken in conjunction with the accompanying drawings in which:

FIG. 1A is a front view of a liquid crystal display television according to a first embodiment of the present invention, and FIG. 1B is a cross-sectional view of FIG. 1A taken along the line A-A;

FIG. 2A is an exploded perspective view of FIG. 1B, and FIG. 2B is a perspective view of FIG. 1A;

FIG. 3A is a front view of an light guide plate and a light source module, FIG. 3B is a cross-sectional view of FIG. 3A taken along the line B-B, and FIG. 3C is a cross-sectional view of a first modified embodiment of FIG. 3A taken along the line B-B;

FIG. 4A is a front view of a light source module according to a second modified embodiment, and FIG. 4B is a cross-sectional view of FIG. 4A taken along the line C-C;

FIG. 5 is a front view of an light guide plate according to a third modified embodiment;

FIG. 6 is a front view showing a process of forming the light guide plate according to the first embodiment shown in FIG. 3A;

FIG. 7A is a front view of the light guide plate and the light source module according to the second embodiment, and FIG. 7B is a cross-sectional view of FIG. 7A taken along the line D-D;

FIG. 8A is a front view of the light source module according to a third embodiment, and FIG. 8B is a cross-sectional view of FIG. 8A taken along the line E-E;

FIG. 9A is a front view of the light source module according to a fourth embodiment, and FIG. 9B is a cross-sectional view of FIG. 9A taken along the line F-F;

FIG. 10A is a front view of the light source module according to a fourth modified embodiment, and FIG. 10B is a cross-sectional view of FIG. 10A taken along the line G-G;

FIG. 11 is a front view of a light source module according to a fifth embodiment;

FIG. 12A is a graph of a luminance characteristic of a pixel versus time in a cathode-ray tube television, and FIG. 12B is a graph of ON/OFF luminance characteristic versus time in an area of a liquid crystal display television; and

FIG. 13A is a front view of a prior art liquid crystal display television, and FIGS. 13 B and C are conceptual diagrams of light guide plates and light sources in the prior art liquid crystal display televisions.

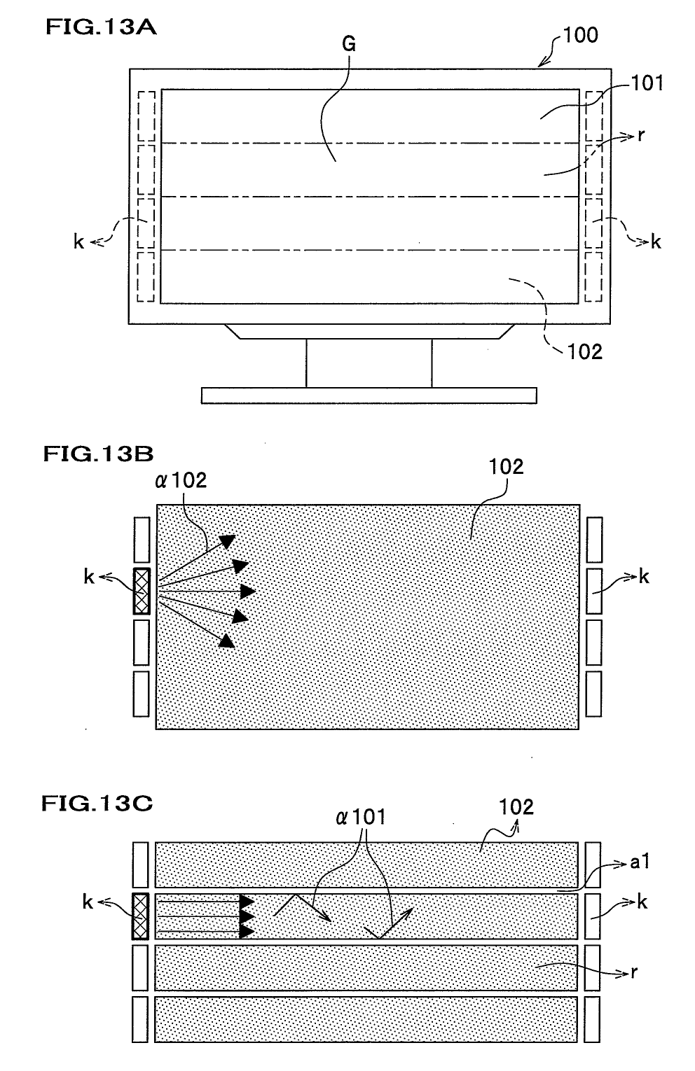

### DETAILED DESCRIPTION OF THE INVENTION

Referring to drawings, embodiments according to the present invention will be described below.

### First Embodiment

### Structure of a Liquid Crystal Display Television 10

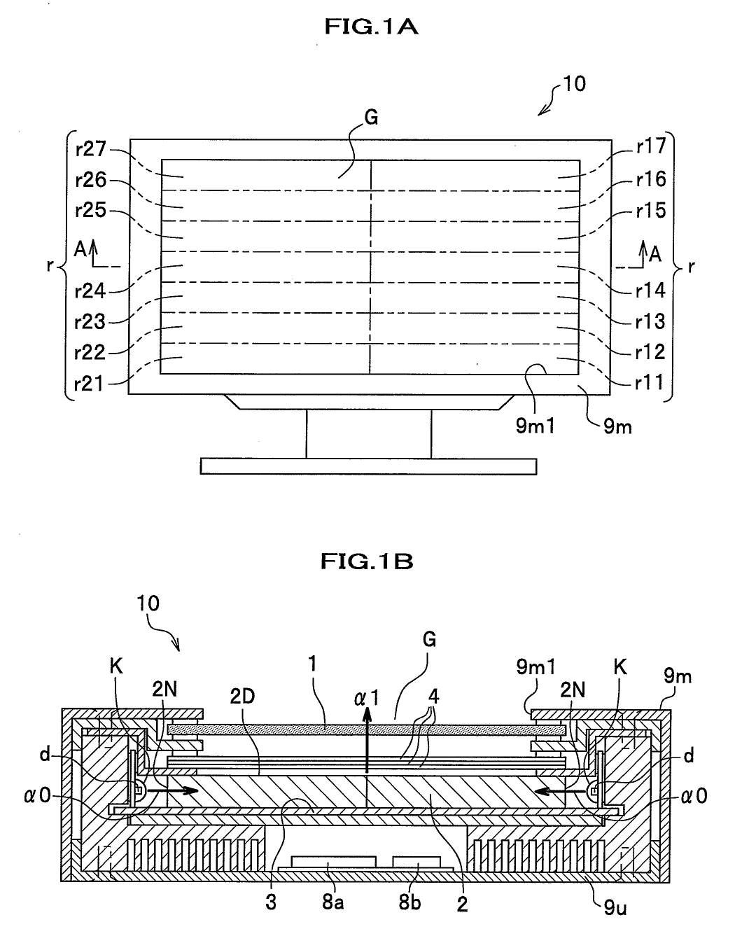

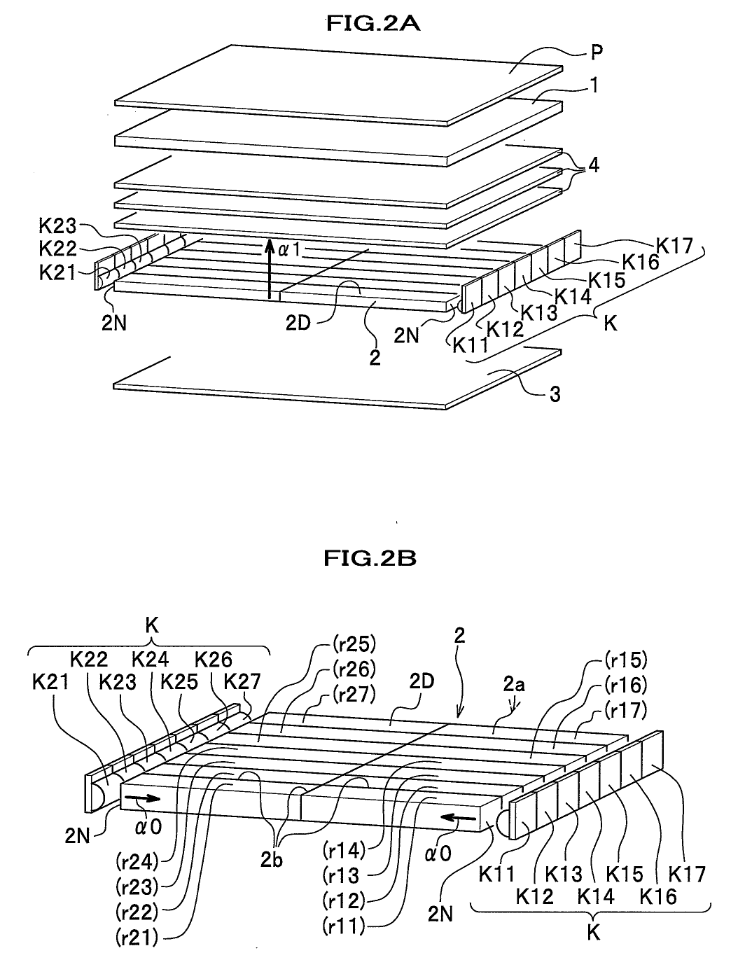

As shown in the front view of FIG. 1A, the liquid crystal display television 10 according to the present invention has a display screen G to show an image. When the image is shown on this display screen G, a liquid crystal layer, to which voltage is applied in response to the image, allows a light whose luminance is changed in response to the image to pass through itself in a direction from rear (backside) to front (front side) to irradiate each pixel of a color filter with the light. And, the each pixel is allowed to display a color in response to the image to show the image. In addition, FIG. 1B is a cross-sectional view of FIG. 1A taken along the line A-A, and FIG. 2A is an exploded perspective view of FIG. 1B, and FIG. 2B is a perspective view of a light source module K and an light guide plate 2 shown in FIG. 2A.

As shown in FIGS. 1B and 2A, as a structure to show an image on the display screen G, the liquid crystal display television 10 includes a liquid crystal panel 1 having a liquid crystal layer to which voltage is applied in response to the image, and a color filter having a pixel which is allowed to display a color with a light passing through the liquid crystal layer; a light source module K having LEDs (Light Emitting Diode) d which is provided on both sides of a printed circuit board, and emits a light in a direction of an arrow aO to allow the light to pass through the liquid crystal panel 1; an light guide plate 2 to take in and guide the light from the light source module K; a white printed dot pattern printed on the backside of the light guide plate 2, and guides the light in a forward direction (such as a direction indicated by an arrow α1) by diffuse reflecting the light traveling in the light guide plate 2; a reflective sheet 3 provided on the backside of the light guide plate 2 (bottom of the liquid crystal display television 10 in FIGS. 1B and 2A) and guides lights, which are not totally reflected by the light guide plate 2 and leak into a bottom side, in a forward direction (such as the direction indicated by the arrow α1 in FIG. 1B) by irregular reflecting the lights; and an optical sheet 4 to uniform the lights passing through the light guide plate 2 in a forward direction (such as the direction indicated by the arrow α1 in FIG. 1B).

Here, the light source module K and the light guide plate 2 to guide lights from the light source module K are referred as a lighting apparatus because they irradiate the liquid crystal panel 1 with lights.

In addition, in FIG. 1B, a transparent front panel P (see FIG. 2A) provided on the outside of the liquid crystal panel 1 is omitted.

As shown in FIG. 1B, the liquid crystal display television 10 includes a resinous front enclosure case 9m having an aperture to form a display screen G, and a rear enclosure case 9u to which the front enclosure case 9m is engaged with screws. On the rear enclosure case 9u, a control unit 8a to overall control the liquid crystal display television 10, and a DC/DC power supply 8b to supply a proper voltage are provided.

The control unit 8a controls the liquid crystal panel 1 and the light source K, etc. and processes an image displayed on the liquid crystal display television 10. For example, the control unit 8a includes a microcomputer having a CPU (Central Processing Unit), a RAM (Random Access Memory), and a ROM (Read Only Memory), and a peripheral circuitry, etc. The liquid crystal display television 10 is overall controlled by executing a program stored in the ROM.

### <Structures of the Light Guide Plate 2 and the Light Source Module K>

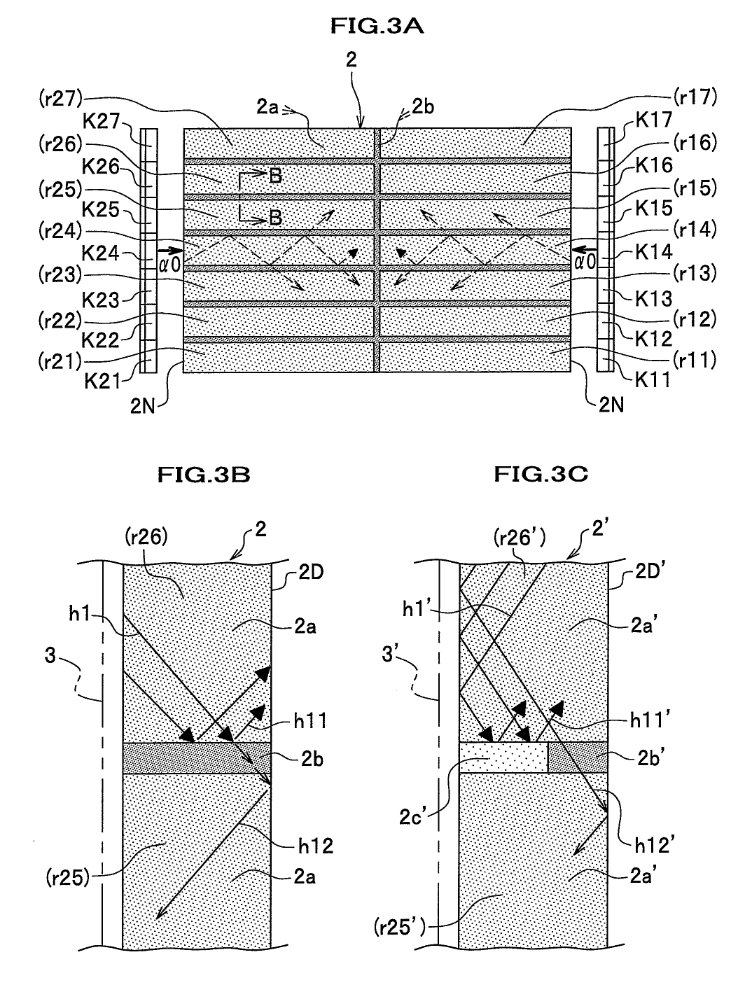

FIG. 3A is a front view of the light guide plate 2 and the light source module K, and FIG. 3B is a cross-sectional view of FIG. 3A taken along the line B-B.

As shown in FIG. 1A, the display screen G is divided into two parts in a transverse direction, and is divided into seven parts in a longitudinal direction. That is, the display screen G is divided into fourteen areas r (r11, r12, . . . r17, r21, r22, . . . , r27). As shown in FIGS. 2B and 3A, the light guide plate 2 includes fourteen first transparent light guide members 2a which are provided corresponding to the fourteen areas r of the display screen G, and a second transparent and adhesive light guide member 2b to connect the first light guide members 2a one another.

When a refractive index of the first light guide member 2a is defined as n1, and a refractive index of the second light guide member 2b is defined as n2, the relationship therebetween is as follows:

1 (refractive index of air)<n2 (refractive index of second light guide member 2b)<n1 (refractive index of first light guide member 2a).

From the above relationship, for example, when the first light guide member 2a is made of a transparent acrylate resin (refractive index n1=1.49), the second light guide member 2b is made of a transparent silicone resin (refractive index n2=1.4).

Also, as shown in FIG. 2B, opposed to the first light guide members 2a corresponding to the fourteen divided areas r (r11, r12, . . . r17, r21, r22, . . . , r27) of the display screen G shown in FIG. 1A, fourteen light source modules K (K11, . . . K17, K21, . . . K27) are provided respectively. In addition, as shown in FIG. 1B, a surface of the light guide plate 2, on which lights from the light source module K are incident and to which the light source module K is opposed, is referred to as an incident plane 2N. Also, a surface of the light guide plate 2, from which lights are emitted toward the liquid crystal panel 1 (see FIG. 1B), is referred to as an exit plane 2D.

On the light source modules K (K11, . . . K17, K21, . . . K27), a plurality of red, blue, and green LEDs d are provided respectively. The lights emitted from each of the LEDs d on the light source modules K (K11, . . . K27) are incident on the incident plane 2N of the light guide plate 2.

These light source modules K (K11, . . . K27) are independently controlled by the control unit 8a so that the luminance is controlled for every area r, any one of the red, blue, and green LEDs d is emphasized, or any two of the red, blue, and green LEDs d are emphasized. In addition, the luminance of the light source modules K (K11, . . . ) are controlled by the applied current.

### <Light Traveling in the Light Guide Plate>

The light emitted from each of the light source modules K (K11, . . . ) is incident on the incident plane 2N of the light guide plate 2 as shown in FIG. 3A, and is emitted from the exit plane 2D of the first light guide member 2a as shown in FIGS. 1B and 2A.

Also, the lights which are incident into the light guide plate 2 are diffused toward the center in the first light guide member 2a accompanied by repetitions of reflection at planes bounding the second light guide member 2b as indicated by a broken arrow in FIG. 3A. And, a part of the lights pass through planes bounding the light guide member 2b, and the light guide member 2b, and are incident into the first light guide member 2a adjacent to the area r as indicated by the broken arrow in FIG. 3A.

Also, as indicated by an arrow in FIG. 3B, a light h1 in the first light guide member 2a of the area r26 travels in the first light guide member 2a (refractive index n1), a light h11, which is a part of the light h1, is reflected at a plane bounding the second light guide member 2b, and other light h12 passes through a plane bounding the second light guide member 2b, and is guided to the first acryl light guide member 2a (refractive index n1) of the adjacent area r25 via the second light guide member 2b (refractive index n2).

Here, when a quantity of the light h1 traveling in the first light guide member 2a of the area r26 is defined as 1, the quantity of the light h11 reflected at a plane bounding the first light guide member 2a is about ¾, and the quantity of the light h12 guided to the first light guide member 2a of the adjacent area r25 via the second light guide member 2b is about ¼.

This phenomenon in which the light traveling in the first light guide member 2a is guided into the adjacent first light guide member 2a of the area r is realized according to the above relationship, i.e., “1 (refractive index of air)<refractive index n2 of second light guide member 2b<refractive index n1 of first light guide member 2a”.

Provided that the above relationship is fulfilled, when other material than the acrylate, and the silicone resins such as a polycarbonate (refractive index n1=1.58) is used as the first transparent light guide member 2a, a transparent and adhesive layer having a higher refractive index than that of the transparent silicone resin (refractive index n2=1.4) can be used as the second light guide member 2b because the refractive index n1 of the polycarbonate is greater than that of the transparent acrylate resin (=1.49).

Likewise, a PET (polyethylene terephthalate) (refractive index n1=1.57) is used as the first light guide member 2a, a transparent and adhesive layer having a higher refractive index than that of the transparent silicone resin (refractive index n2=1.4) can be used as the second light guide member 2b because the refractive index n1 of the PET is greater than that of the transparent acrylate resin (=1.49).

Although some examples are disclosed as the first light guide member 2a and the second light guide member 2b, it is thought that about 1.5 is the most suitable as the refractive index n1 of the first light guide member 2a because the refractive index n2 of the second light guide member 2b is 1.4+/−0.5.

However, the relationship between the refractive index n1 of the first light guide member 2a and the refractive index n2 of the second light guide member 2b will be relatively determined.

According to the above described structure, the second light guide member 2b is provided adjacent to the first light guide member 2a, and the following relationship “1<refractive index n2 of second light guide member 2b<refractive index n1 of first light guide member 2a” is established. Therefore, a part of lights which are emitted from the light source module K and travel in the first light guide member 2a are guided into the first light guide member 2a of the adjacent area via the second transparent and adhesive light guide member 2b. As a result, an irregular color for every area r of the light guide plate 2 (see FIG. 3A) caused by variations in the light source modules K, i.e., the irregular color for every area r of the display screen G (see FIG. 1A) can be improved.

### First Modified Embodiment

Next, referring to FIG. 3C, a first modified embodiment will be explained. In addition, FIG. 3C is a cross-sectional view of a first modified embodiment of FIG. 3A taken along the line B-B.

As shown in FIG. 3C, in a light guide plate 2′ of the first modified embodiment, a third light guide member 2c′, which is other transparent and adhesive layer than the second light guide member 2b′, is provided between the first light guide members 2a′ of the first embodiment shown in FIG. 3B.

With respect to the other structures, because they are similar to the first embodiment, detailed explanations are omitted.

When a refractive index of the third light guide member 2c′ is defined as n3, the following relationship, i.e.,

“1 (refractive index of air)<refractive index n3 of third light guide member 2c′<refractive index n1 of first light guide member 2a′” is established.

Therefore, a transparent material for the third light guide member 2c′ having the refractive index n3 which fulfils the above condition is selected to use.

For example, the first light guide member 2a′ is made of the transparent acrylic resin (refractive index n1=1.49), and the third light guide member 2c′ is made of the transparent silicone resin (refractive index n2=1.4). Here, the first light guide member 2a may be applied to the second light guide member 2b′.

As shown in FIG. 3C, a part of lights h1′, which are emitted from the light source module K and travel in the first light guide member 2a′ (refractive index n1) of an area r26′, are reflected at a plane bounding the second light guide member 2b′ to result in lights h11′, and another part of lights h1′ are guided into the first light guide member 2a′ of a area r25′ via the second light guide member 2b′ (refractive index n2) to result in lights h12′,

According to the above described structure, the second light guide member 2b′ and the third light guide member 2c′ are provided adjacent to the first light guide member 2a′. Therefore, a part of lights which are emitted from the light source module K and travel in the first light guide member 2a′ are guided into the first light guide member 2a′ of the adjacent area via a second transparent and adhesive light guide member 2b′. As a result, an irregular color for every area r′ of the light guide plate 2′ (see FIG. 3A) caused by variations in the light source module K, i.e., the irregular color for every area r′ of the display screen G (see FIG. 1A) can be improved.

### Second Modified Embodiment

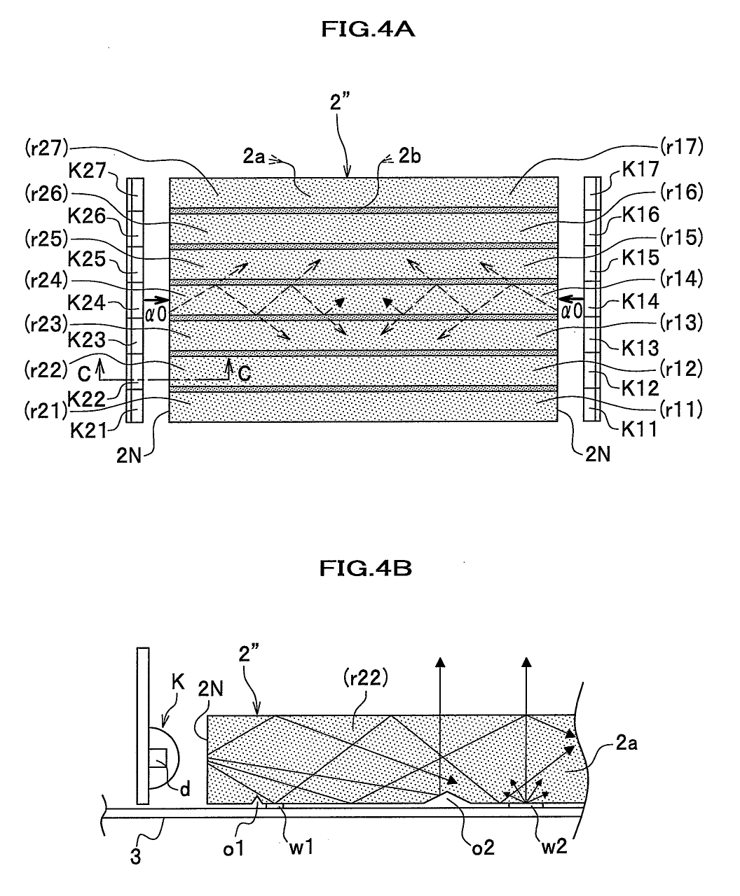

Next, referring to FIG. 4, a second modified embodiment will be explained. In addition, FIG. 4A is a front view of an light guide plate 2″ and light source modules K (K11, . . . K27) according to a second modified embodiment, and FIG. 4B is a cross-sectional view of FIG. 4A along the line C-C.

As shown in FIG. 4A, the light guide plate 2″ according to the second modified embodiment has a structure in which the display screen G (see FIG. 1) is divided into seven parts only in a longitudinal direction. For example, consider the area r11 and the area r21 shown in FIG. 1 as a single area. Corresponding to these seven areas r, seven first transparent light guide members 2a are provided, and these seven first light guide members 2a are connected one another via the second light guide members 2b (i.e., the transparent and adhesive layers).

As shown in FIG. 4B, in order to uniform the lights in the first light guide member 2a of the light guide plate 2″, a small white ink dot w1 having light-diffusion and low-reflection properties is formed at the end, at which the luminance of light emitted from the light source module K 22 is high, on a backside of the light guide plate 2″ (i.e., on the surface facing the reflective sheet 3). Meanwhile, a white ink dot w2 having light-diffusion property is formed. The nearer to the center at which the luminance of light emitted from the light source module K 22 is low, the higher the reflection property. As a result, the quantity of the reflection becomes larger toward the center, and the uniformity of lights in the area r22 (see FIGS. 1 and 4A) is achieved.

Also, other material than the white ink having light-diffusion and high-reflection properties may be used. Also, as long as the quantity of the reflection becomes larger toward the center in the light guide plate 2″, other form than the dot may be used.

Also, when the first light guide member 2a is injection molded, a small recess o1 having low-reflection property is formed at the end, at which the luminance of light emitted from the light source module K 22 is high. Meanwhile, recesses o2, . . . are formed, the nearer to the center at which the luminance of light emitted from the light source module K 22 is low, the higher the reflection property. As a result, the quantity of the reflection becomes larger toward the center, and the uniformity of lights in the area r22 (see FIGS. 1 and 4A) is achieved.

In addition, although white ink dots w1, w2, . . . and recesses o1, o2, . . . formed at the time of the injection molding of a second light guide member 2a are disclosed as the structures to uniform lights in the area r22 (see FIGS. 1 and 4A), at least one of these structures may be used.

The area r12 of the display screen G (see FIGS. 1 and 4A) is also the structure in which the nearer to the center, the higher the reflection property as described above. Other areas r11, . . . r27 are the same.

Because other members are the same as those of the first embodiment, similar reference numbers are used to donate similar members, and detailed explanations are omitted.

According to the above described structure, because a light traveling in the first light guide member 2a is guided into other first light guide member 2a of an adjacent area via the second light guide member 2b, and an irregular color for every area r of the light guide plate 2″ (see FIG. 1A) caused by variations in the light source module K can be improved.

In addition, as long as the reflection in the direction of the side of the liquid crystal panel 1 is satisfied, any configuration of the recesses o1, o2, . . . of the first light guide member 2a may be selected.

### Third Modified Embodiment

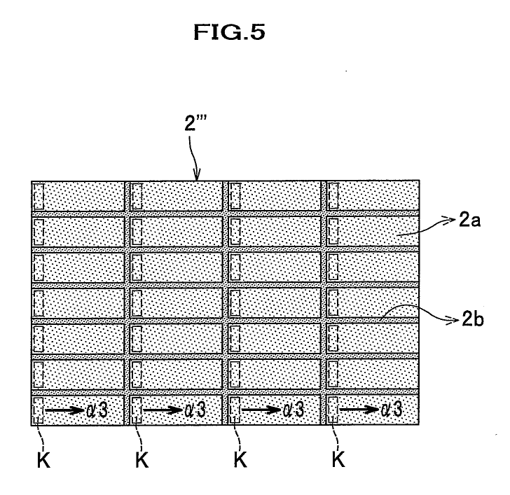

Next, referring to FIG. 5, a third modified embodiment will be explained. In addition, FIG. 5 is a front view of an light guide plate 2′″ according to the third modified embodiment.

As shown in FIG. 5, the light guide plate 2′″ according to the third modified embodiment is divided into seven parts in a longitudinal direction, and is divided into four parts in a transverse direction. That is, the light guide plate 2′″ is divided into twenty eight areas. Opposed to these twenty eight areas, twenty eight first light guide members 2a are provided, and these first light guide members 2a are connected one another via the second light guide members 2b.

Also, corresponding to these twenty eight areas, twenty eight light sources K are provided on the backside of the light guide plate 2′″ (backside of FIG. 5) in an approximately the same direction as the extension of the light guide plate 2′″ (see arrow a3 in FIG. 5). And, the reflective sheet 3 on the backside of the light guide plate 2′″ is formed so that the farther from the light source K, the nearer to the front (front side of FIG. 5), i.e., to the light guide plate 2′″, and lights emitted from twenty eight light sources K in the areas are uniformed and directed toward the front (toward the front in FIG. 5, in a direction indicated by arrow α1 in FIG. 1).

Because other members are the same as those of the first embodiment, detailed explanations are omitted.

According to the above described structure, because a light traveling in the first transparent light guide member 2a is guided into other first light guide member 2a of an adjacent area via the transparent second light guide member 2b, an irregular color for every area r of the light guide plate 2′″ (see FIG. 1A) caused by variations in the light source module K can be improved.

### <Material Candidates of the Transparent and Adhesive Layer and Forming Process Thereof>

Next, the forming process of the transparent and adhesive layer will be explained. In addition, the transparent and adhesive layer means the second light guide member 2b according to the first embodiment shown in FIG. 3A, the second light guide member 2b and the third light guide member 2c according to the first modified embodiment shown in FIG. 3C, the second light guide member 2b according to the second modified embodiment shown in FIG. 4A, and the second light guide member 2b according to the third modified embodiment shown in FIG. 5.

Here, the second transparent and adhesive light guide member 2b of the light guide plate 2 according to the first embodiment shown in FIG. 3A will be explained.

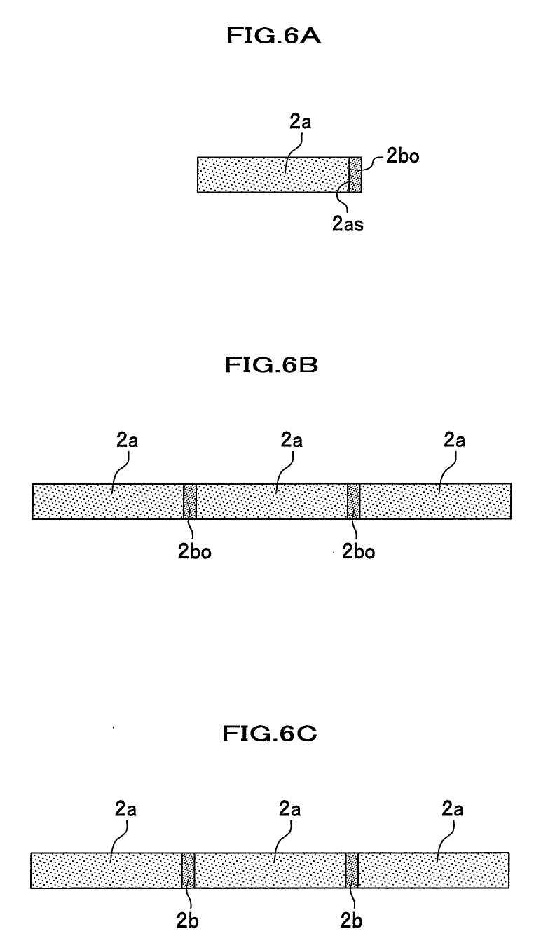

FIG. 6 is a front view showing the process of forming the light guide plate 2 according to the first embodiment shown in FIG. 3A.

First, the polycarbonate (refractive index n1=1.58) is used as the material of the first light guide member 2a.

As the material of the second light guide member 2b, an acrylate resin having low refractive index such as an acrylate monomer whose side-chain alkyl group has large numbers of carbons described below.

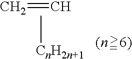

In the above chemical formula, for example, when n is equal to or greater than 6, the refractive index n2 is decreased to about 1.47. This organic compound is dissolved in a solvent to produce a solvent paste 2bo. In addition, a tetrahydrofuran, and a dioxane, etc. can be used as the solvent.

And, as shown in FIG. 6A, this solvent 2bo is applied to a side 2as of a substrate of the first light guide member 2a (see FIG. 3A), as shown in FIG. 6B, the substrates of the first light guide member 2a are attached one another and the solvent is evaporated by heat curing, and as shown in FIG. 6C, the first light guide members 2a are connected one another via the second light guide member 2b. In addition, the light guide plate 2″ according to the second modified embodiment (see FIG. 4A) and the light guide member 2bo according to the third modified embodiment (see FIG. 5) are the same.

Also, when the third light guide member 2c′ according to the first modified embodiment shown in FIG. 3C is attached to the first light guide member 2a′ and the second light guide member 2b′, similar material can be used as the adhesive layer. Also, the thickness of this adhesive layer is 60 micrometers-1 millimeter. The material itself of the third light guide member 2c′ may be the material of this adhesive layer. In addition, in such a case, the first light guide member 2a′ is made of a polycarbonate (refractive index n1=1.58).

Here, the second light guide members 2b′ made from a silicon system resin (refractive index=1.42) can be attached one another by similar heat curing.

### Second Embodiment

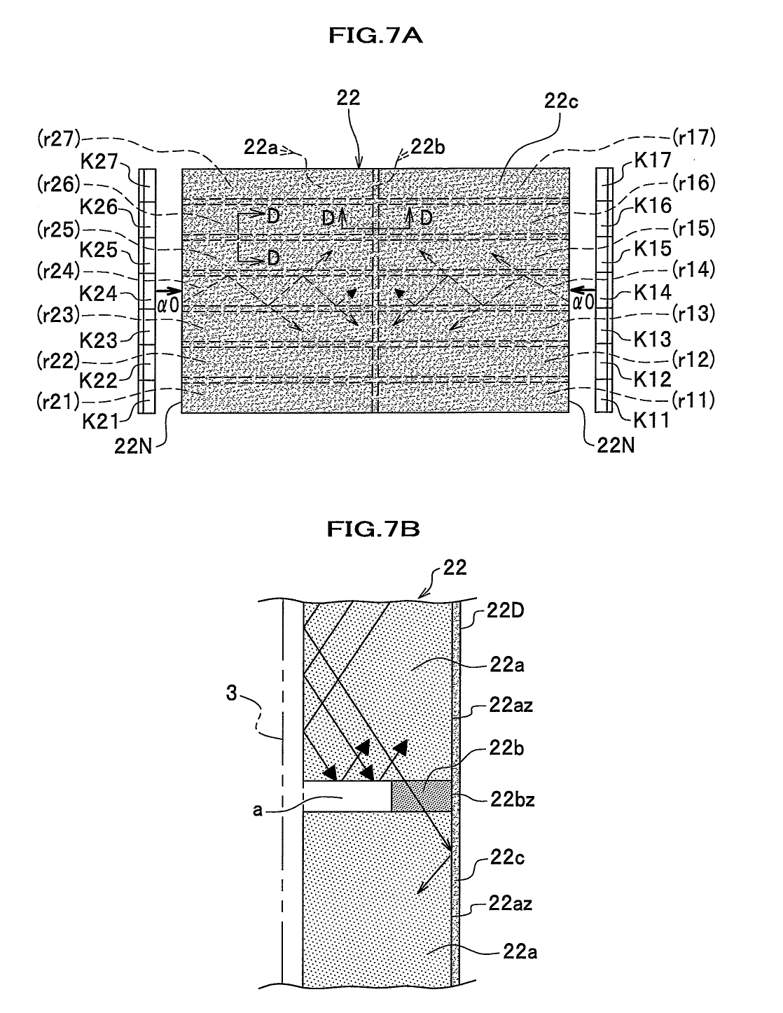

Next, referring to FIG. 7, a second embodiment will be explained. In addition, FIG. 7A is a front view of an light guide plate 22 and light source modules K (K11, . . . K17, K21, . . . K27) according to the second embodiment, and FIG. 7B is a cross-sectional view of FIG. 7A along the line D-D.

As shown in FIG. 7B, in the light guide plate 22 according to the second embodiment, a third light guide member 22c, which is the transparent and adhesive layer, is formed on the front face of the light guide plate 2 (i.e., on the surface above which the liquid crystal panel is provided) according to the first embodiment shown in FIGS. 3A and 3B.

As shown in FIG. 7A, the light guide plate 22 according to the second embodiment is divided into fourteen areas r11, . . . r17, r21, . . . r27. In each area, as shown in FIG. 7B, a first transparent light guide member 22a is provided. These fourteen first transparent light guide members 22a are connected one another via the second transparent light guide member 22b on their front face (i.e., on the surface above which the liquid crystal panel is provided). And, an air layer a (i.e., a space) is provided at the backside of the second light guide member 22b (i.e., the surface on which the reflective sheet 3 is provided).

Here, as shown in FIG. 7B, a front face 22az of each first light guide member 22a, and a front face 22bz of each second light guide member 22b are approximately coplanar.

And, as shown in FIG. 7B, the third light guide member 22c, which is the transparent and adhesive layer, is formed on the front face of the first light guide member 22a and the second light guide member 22b (i.e., on the surface above which the liquid crystal panel is provided) all over the light guide plate 22 (see FIG. 7A).

When a refractive index of the first light guide member 22a is defined as n1, and a refractive index of the second light guide member 22b is defined as n2, the relationship therebetween is as follows:

1 (refractive index of air)<n2 (refractive index of second light guide member 22b)<n1 (refractive index of first light guide member 22a).

In order to fulfill the above relationship, for example, the first light guide member 22a is made of a transparent acrylate resin (refractive index n1=1.49), the second light guide member 22b is made of a transparent silicone resin (refractive index n2=1.4), and the third light guide member 22c, which is the transparent and adhesive layer, is made of a transparent and adhesive elastomeric tape.

Alternatively, the first light guide member 22a is made of a transparent polycarbonate resin (refractive index n1=1.58), and the second light guide member 22b is made of a transparent resin having higher refractive index than that of the transparent silicone resin (refractive index n2=1.4), and the third light guide member 22c, which is the transparent and adhesive layer, is made of the transparent and adhesive elastomeric tape.

For example, the thickness of the third light guide member 22c, which is the transparent and adhesive layer, is 100-200 micrometers in small products such as a cellular phone, etc. and is 500 micrometers in large products such as a liquid crystal display television, etc. However, the thickness of the third light guide member 22c, which is the transparent and adhesive layer, can be selected arbitrarily.

As shown in FIG. 7A, corresponding to the fourteen areas r11, . . . r17, r21, . . . r27 of the light guide plate 22, fourteen light source modules K (K11, K12, . . . K17, K21, K22, . . . K27) are provided, and independently controlled like the first embodiment.

Because other members are the same as those of the first embodiment, similar reference numbers are used to donate similar members, and detailed explanations are omitted.

According to the above described structure, in addition to the operational advantage of the first embodiment, the connection between the first light guide member 22a and the second light guide member 22b is reinforced and the strength of the light guide plate 22 is improved because the third light guide member 22c, which is the transparent and adhesive layer, is formed on the front face of the first light guide member 22a and the second light guide member 22b in the light guide plate 22.

Also, the front face 22az of the first light guide member 22a and the front face 22bz of the second light guide member 22b (i.e., the surfaces of the first light guide member 22a and the second light guide member 22b above which the liquid crystal panel is provided) in the light guide plate 22 are approximately coplanar. And, the third light guide member 22c, which is the transparent and adhesive layer, is also formed. Therefore, the leakage of light from the first light guide member 22a into the front portion of the front face 22az of the adjacent first light guide member 22a (i.e., into the portion in which the liquid crystal panel 1 is provided) caused by unevenness of the first light guide member 22a and the front face 22az is suppressed. As a result, locally high luminance in the light guide plate 22 (see FIG. 7A) is suppressed, and a uniformity of lights in the light guide plate 22 is improved.

### Third Embodiment

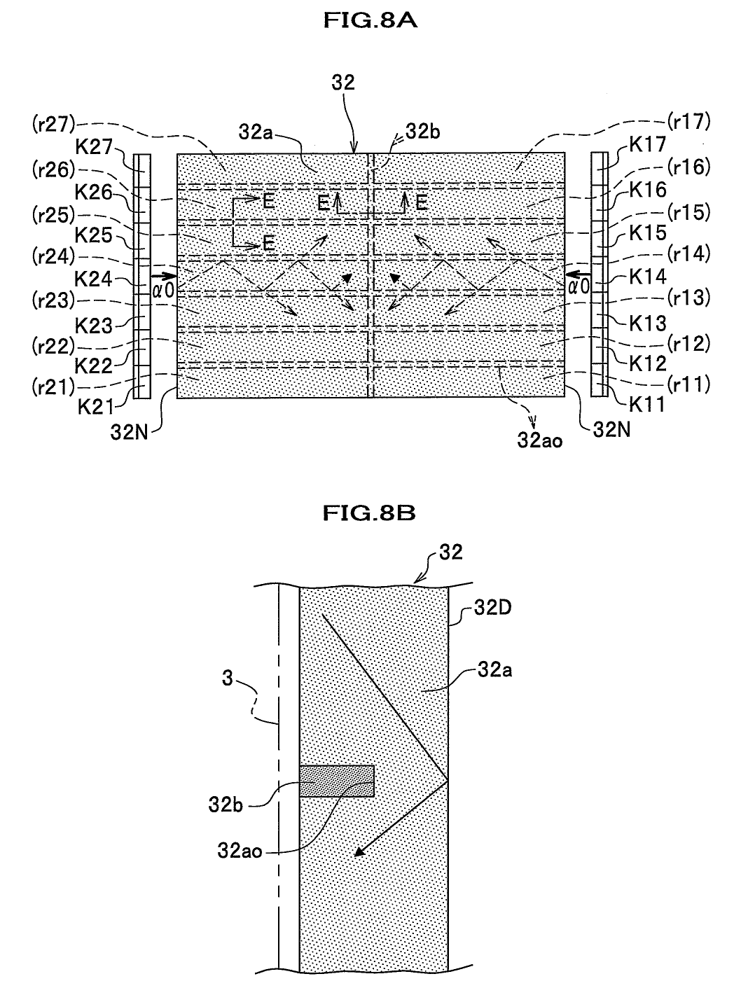

Next, referring to FIG. 8, a third embodiment will be explained. In addition, FIG. 8A is a front view of an light guide plate 32 and light source modules K (K11, . . . K17, K21, . . . K27) according to the third embodiment, and FIG. 8B is a cross-sectional view of FIG. 8A taken along the line E-E.

As shown in FIG. 8, the light guide plate 32 according to the third embodiment is wholly made of one sheet of a first transparent light guide member 32a. As shown in FIG. 8B, the light guide plate 32 is divided into fourteen areas r11, . . . r17, r21, . . . r27 by forming a groove portion 32ao having rectangular cross-section on a backside of this first transparent light guide member 32a (i.e., on the surface facing the reflective sheet 3). In this groove portion 32ao, a second transparent light guide member 32b is filled.

When a refractive index of the first light guide member 32a is defined as n1, and a refractive index of the second light guide member 32b is defined as n2, the relationship therebetween is as follows: n2 (refractive index of second light guide member 32b)<n1 (refractive index of first light guide member 32a).

For example, the first light guide member 32a is made of a transparent acrylate resin (refractive index n1=1.49), and the second light guide member 32b is made of a transparent silicone resin (refractive index n2=1.4).

Alternatively, the first light guide member 32a is made of a transparent polycarbonate resin (refractive index n1=1.58), and the second light guide member 32b is made of a transparent resin having higher refractive index than that of the transparent silicone resin (refractive index n2=1.4).

The groove portion 32ao of the first light guide member 32a in the light guide plate 32 is formed at the time of the injection molding. Alternatively, the first transparent light guide member 32a having the size of the light guide plate 32 shown in FIG. 8A is prepared, and the groove portion 32ao is formed by additional manufacturing. In addition, in forming of the groove portion 32ao, the less manufacturing steps are desirable.

As shown in FIG. 8A, corresponding to fourteen areas r11, . . . r17, r21, . . . r27 of the light guide plate 32, fourteen light source modules K (K11, K12, . . . K17, K21, K22, . . . K27) are provided, and independently controlled like the first embodiment.

According to the above described structure, a part of lights traveling in one area r of the first light guide member 22a are guided into the adjacent area r as indicated by an arrow in FIG. 8A, and an irregular color for every area r of the light guide plate 32 (see FIG. 3A) caused by variations in the light source module K can be improved.

Also, because the light guide plate 32 is made of one sheet of the first light guide member 32a, the strength is improved. Also, when the groove portion 32ao of the first light guide member 32a is formed by the injection molding, the manufacturing steps are reduced.

In addition, the depth of the groove portion 32ao (i.e., the dimension of the filled second light guide member 32b in a direction of the thickness of the first light guide member 32a) can be adjusted arbitrarily depending on a state of light guiding into the adjacent area r.

Also, a configuration of the cross-section of the groove portion 32ao can be selected arbitrarily from other configurations than the rectangle such as trapezoid, semicircle, and curved surface, etc.

### Fourth Embodiment

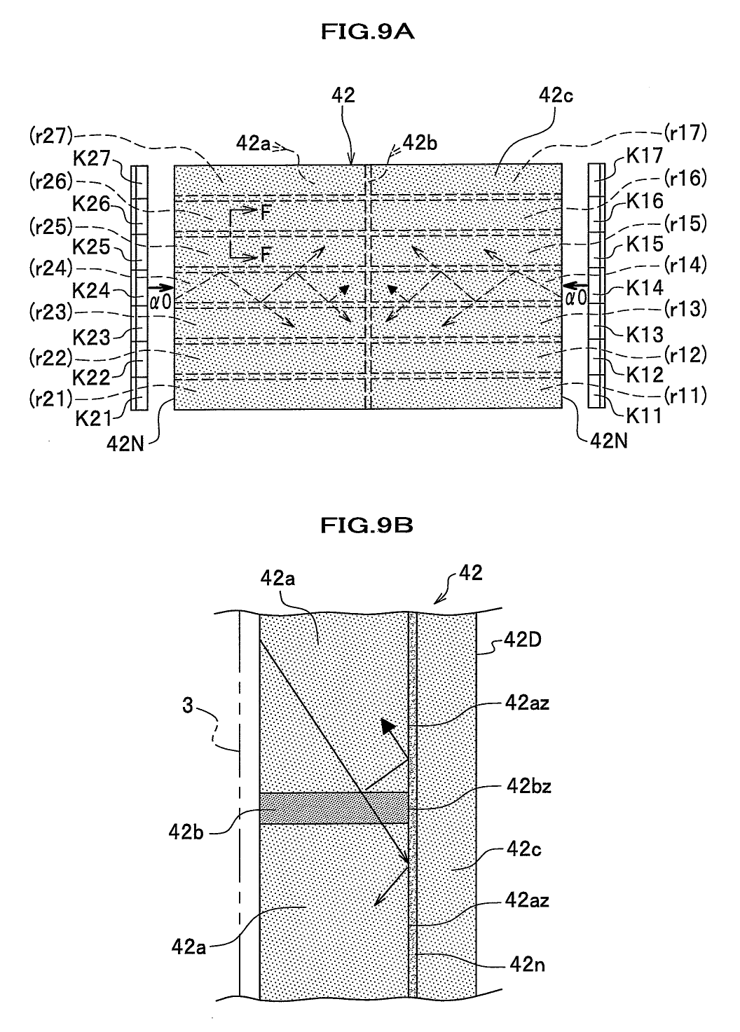

Next, referring to FIG. 9, a fourth embodiment will be explained. In addition, FIG. 9A is a front view of an light guide plate 42 and light source modules K (K11, . . . K17, K21, . . . K27) according to a fourth embodiment, and FIG. 9B is a cross-sectional view of FIG. 9A taken along the line F-F.

As shown in FIG. 9A, the light guide plate 42 according to the fourth embodiment is divided into fourteen areas r (r11, . . . r17, r21, . . . r27), and corresponding to the fourteen areas r (r11, . . . r17, r21, . . . r27), first light guide members 42a are provided. These first light guide members 42a are connected one another via an light guide member 42b. As shown in FIG. 9B, a third transparent light guide member 42c having the same size as and thinner thickness than those of the light guide plate 42 is attached on a front face 42az of the connected first light guide members 42a and on a front face 42bz of the second light guide member 42b (i.e., on the surface above which the liquid crystal panel is provided) via a transparent and adhesive layer 42n.

In addition, the front face 42az of the connected first light guide members 42a and the front face 42bz of the second light guide member 42b are approximately coplanar.

When a refractive index of the first light guide member 42a is defined as n1, and a refractive index of the second light guide member 42b is defined as n2, the relationship therebetween is as follows:

1 (refractive index of air)<n2 (refractive index of second light guide member 42b)<n1 (refractive index of first light guide member 42a).

In order to fulfill the above relationship, for example, the first light guide member 42a is made of a transparent acrylate resin (refractive index n1=1.49), and the second light guide member 42b is made of a transparent silicone resin (refractive index n2=1.4). In addition, the third light guide member 42c may be made of any transparent and adhesive layer such as the transparent acrylate resin (refractive index n1=1.49) which is the material for the first light guide member 42a. Also, the transparent and adhesive layer 42n is made of a material such as the transparent and adhesive elastomeric tape.

Alternatively, the first light guide member 42a is made of a transparent polycarbonate resin (refractive index n1=1.58), and the second light guide member 42b is made of a transparent resin having higher refractive index than that of the transparent silicone resin. In addition, the third light guide member 42c may be made of any transparent and adhesive layer such as the transparent polycarbonate resin (refractive index n1=1.58) which is the material for the first light guide member 42a. Also, the transparent and adhesive layer 42n is made of a material such as the transparent and adhesive elastomeric tape.

And, as shown in FIG. 9A, corresponding to the fourteen areas r (r11, . . . r17, r21, . . . r27) of the light guide plate 42, fourteen light source modules K (K11, K12, . . . K17, K21, K22, . . . K27) are provided, and independently controlled like the first embodiment.

In order to manufacture the light guide plate 42 according to the fourth embodiment, the third transparent light guide member 42c having the same size as and thinner thickness than those of the light guide plate 42 shown in FIG. 9A is firstly prepared.

Successively, the transparent and adhesive layer 42n is applied on the third transparent light guide member 42c.

Successively, the first transparent light guide members 42a are attached to the fourteen areas r on the transparent and adhesive layer 42n.

Successively, as shown in FIG. 9B, the transparent second light guide member 42b is filled between the first light guide members 42a on the transparent and adhesive layer 42n in the third light guide member 42c. The filled second light guide member 42b is cured to complete the light guide plate 42.

According to the above described structure, a part of lights traveling in one area r of the first light guide member 42a are guided into the adjacent area r as indicated by an arrow in FIG. 9, and an irregular color for every area r of the light guide plate 42 (see FIG. 9A) caused by variations in the light source module K can be improved.

Also, the connection between the first light guide member 42a and the second light guide member 42b is reinforced and the strength is improved because the third light guide member 42c is attached to the first light guide member 42a and the second light guide member 42b via the transparent and adhesive layer 42n.

### Modified Embodiment

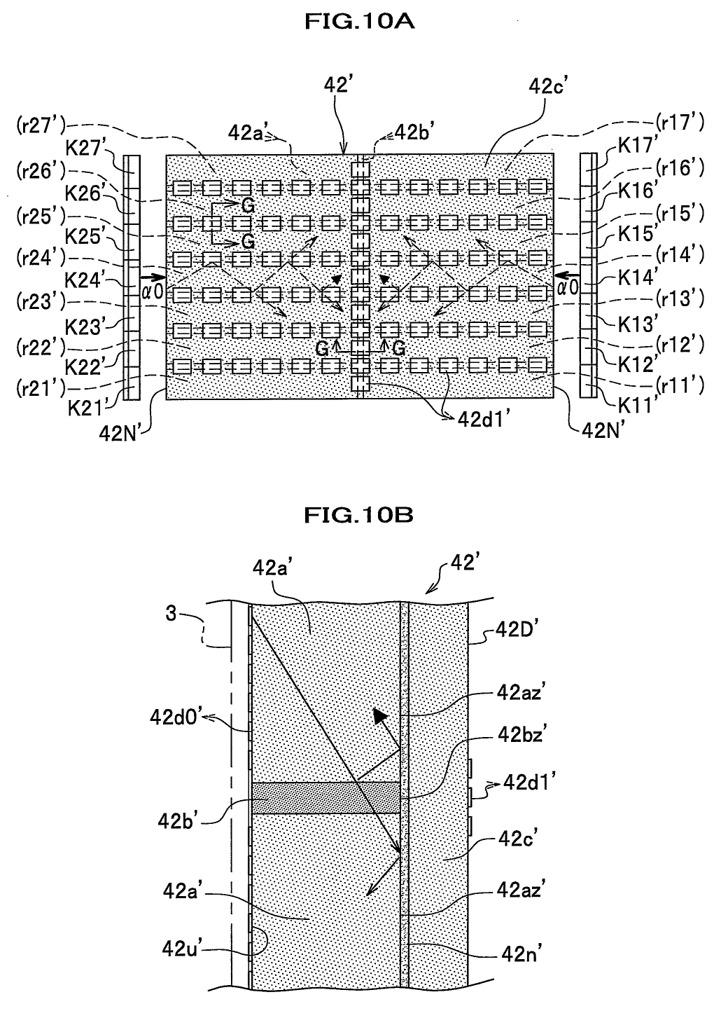

Next, referring to FIG. 10, a fourth modified embodiment will be explained. In addition, FIG. 10A is a front view of an light guide plate 42′ and light source modules K′ (K11′, . . . K17′, K21′, . . . K27′) according to the fourth modified embodiment, and FIG. 10B is a cross-sectional view of FIG. 10A taken along the line G-G.

In the fourth modified embodiment, for the purpose of suppressing an irregular luminance occurring at a second light guide member 42b′ which is a boundary portion between the first light guide members 42a′ shown in FIG. 10A, a plurality of white dots 42d1′ are printed on an exit plane 42D′, which is opposed to a second light guide member 42b′ of the boundary portion, and its vicinity using a white ink.

In addition, each of the white dots 42d1′ shown in FIG. 10A is illustrated as one piece for easy viewing of a plurality of white dots 42d1′ shown in FIG. 10B.

The ink used for these white dots 42d1′ may be the same as that for white dots 42d0′ formed on a backside 42u′ of the light guide plate 42′ shown in FIG. 10B. Also, it is desirable to suppress the irregular luminance by adjusting the ink density of the white dots 42d1′.

According to the above described structure, the white dots 42d1′ are formed on the exit plane 42D′, which is opposed to the second light guide member 42b′ of the boundary portion between the first light guide members 42a′ in the light guide plate 42′ shown in FIG. 10A, and its vicinity. Therefore, excess lights, which cause the irregular luminance at the boundary portion (i.e., at the second light guide member 42b′), are reflected toward the light guide plate 42′ and are diffused in the light guide plate 42′. As a result, the irregular luminance in the light guide plate 42′ can be suppressed.

In addition, although the white dots 42d1′ are formed on the exit plane 42D′ by printing in this modified embodiment, other methods than printing can be used.

Also, although white dots 42d1′ are disclosed in this modified embodiment, the pattern is not limited to the dot pattern, and other patterns than dot such as spotted pattern, etc can be selected.

In addition, reflecting members to suppress an irregular luminance such as the white dots 42d1′ formed on the exit plane 42D′ in the light guide plate 42′ according to the modified embodiment can be applied to similar boundary portions in light guide plates according to the first, second, and third embodiments.

### Fifth Embodiment

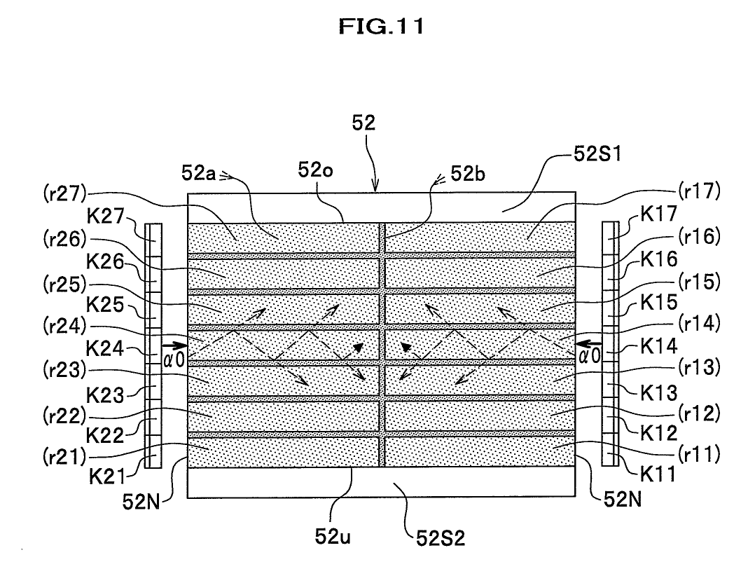

Next, referring to FIG. 11, a fifth embodiment will be explained. In addition, FIG. 11 is a front view of an light guide plate 52 and light source modules K (K11, . . . K17, K21, . . . K27) according to the fifth embodiment.

As shown in FIG. 11, the light guide plate 52 according to the fifth embodiment has a similar structure to that of the light guide plate 2 according to the first embodiment shown in FIG. 3A, and light guide plate supporting members 52S1 and 52S2 are provided on a top surface 52o and a bottom surface 52u of the light guide plate 52 respectively. The light guide plate supporting members 52S1 and 52S2 are reinforcing members for the light guide plate 52, and can absorb a warpage caused by thermal expansion of the light guide plate 52.

As shown in FIG. 11, the light guide plate 52 is divided into fourteen areas r (r11, . . . r17, r21, . . . r27), and corresponding to the fourteen areas r (r11, . . . r17, r21, . . . r27), first light guide members 52a are provided. These first light guide members 52a are connected one another via a second light guide member 52b. The light guide plate supporting members 52S1 and 52S2 are attached to the top surface 52o and the bottom surface 52u respectively using an adhesive, etc.

The light guide plate supporting members 52S1 and 52S2 reinforce the light guide plate 52 which is made by connecting the first light guide members 52a via the second light guide member 52b. Also, when the liquid crystal display television 10 is used, the light guide plate supporting members 52S1 and 52S2 absorb deformation caused by thermal expansion of the light guide plate 52 to suppress the warpage.

A base material of the light guide plate supporting members 52S1 and 52S2 is a rubber such as a butadiene rubber, a neoprene rubber, or an isoprene rubber, or an elastic material such as a sponge. By using the rubber, or the sponge, etc., the light guide plate 52 is reinforced with their strengths. Also, the deformation caused by the thermal expansion of the light guide plate 52 is absorbed by elasticity of the light guide plate supporting members 52S1 and 52S2 to suppress the warpage of the light guide plate 52. These rubber and sponge are low cost and suitable. In addition, as long as the light guide plate 52 is reinforced and the deformation caused by the thermal expansion is absorbed, other material than the rubber and the sponge may be used.

Also, the connection between the light guide plate 52 and the light guide plate supporting members 52S1 and 52S2 may be made by using an adhesive such as an epoxy adhesive which varies across the ages very little. Alternatively, a double-faced powerful adhesive tape including more acrylic acid than usual may be used. The method for connecting can be selected arbitrarily.

According to the above described structure, the light guide plate supporting members 52S1 and 52S2 are provided on the top surface 52o and the bottom surface 52u of the light guide plate 52 to reinforce the light guide plate 52 and to absorb the deformation caused by the thermal expansion of the light guide plate 52. As a result, the warpage is suppressed to increase the reliability of the light guide plate 52.

In addition, the light guide plate supporting members 52S1 and 52S2 can be applied to the light guide plates according to the first, second, third, and fourth embodiments.

### SUMMARY

As described above, according to the first, second, third, fourth, and fifth embodiments, a light traveling in an area of an light guide plate can be guided into the adjacent area, and an irregular luminance and an irregular color for every area of the display screen G (see FIG. 1A) caused by variations in the light source module K can be decreased.

Therefore, the performance of area control for an image on the display screen G can be improved.

Also, at a high luminance area on the display screen G (see FIG. 1A), the light source module K is controlled by the control unit 8a to increase a light quantity. On the other hand, at a low luminance area on the display screen G (see FIG. 1A), the light source module K is controlled by the control unit 8a to decrease the light quantity. As a result, an electric power consumption of a backlight can be decreased.

For example, because a large-screen display consumes large electric power, it is required to be low-electric-power-consumption. Also, because a mobile device such as a cellular phone is a battery-driven device, it is required to be low-electric-power-consumption. Also, because a low luminance image appears in watching one-segment broadcasting or movie on the cellular phone, an effect of decreasing electric power consumption can be expected.

Therefore, the present invention can be widely utilized in these devices.

Also, at a white portion of an image on the display screen G (see FIG. 1A), the light source module K is controlled by the control unit 8a to increase a light quantity. On the other hand, at a black portion of the image, the light source module K is controlled by the control unit 8a to decrease the light quantity. As a result, a ratio between luminance of white and black portions on the display screen G (see FIG. 1A) increases, and a contrast of the image is improved.

As described above, at the black portion of the image on the display screen G (see FIG. 1A), the light source module K is controlled to decrease the light quantity. Therefore, an electric power consumption (i.e., a heat generation) is suppressed, and an increase in temperature in the liquid crystal display television 10 can be suppressed.

### <Enhancement of Moving Image Quality>

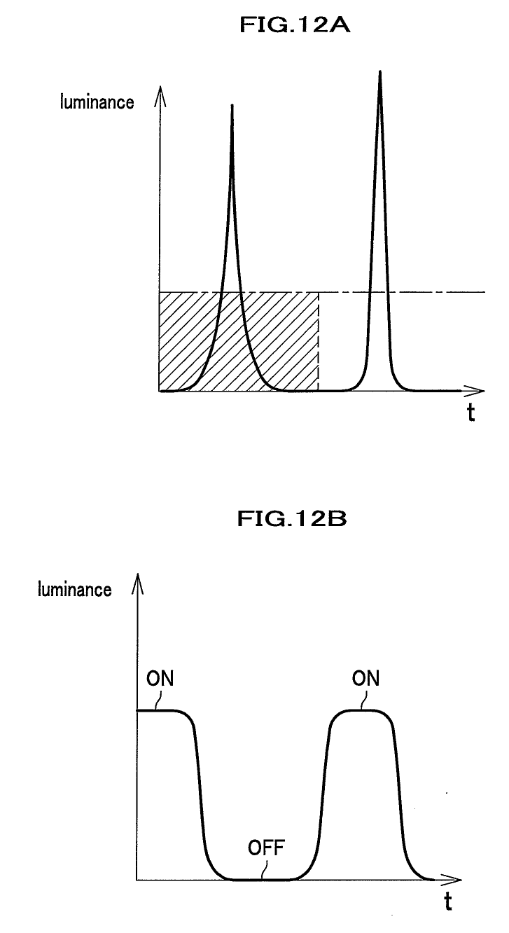

FIG. 12A is a graph of a luminance characteristic of a pixel versus time in a cathode-ray tube television, and FIG. 12B is a graph of ON/OFF luminance characteristic versus time t in an area of a liquid crystal display television 10.

In the cathode-ray tube television, when an image is displayed on the display screen G (see FIG. 1A), corresponding to a scanning line, an electron beam strikes on a fluorescent tube per one frame for every 60 Hz to display a pixel. Therefore, after the electron beam passes through, a representation of the pixel terminates at once.

For this reason, as shown in FIG. 12A, when attention is directed to a pixel, the luminance increases and decreases sharply with respect to the time axis t. That is, FIG. 12A shows a non-hold type representation.

For this reason, when a moving image is displayed, a pixel is displayed and terminated at once corresponding to one image, a next pixel is displayed and terminated at once corresponding to next image, and the same process is repeated. As a result, the moving image is not blurred.

On the other hand, in the liquid crystal display appliance, as shown in FIG. 12B, when an image is displayed on the display screen G (see FIG. 1A) of the liquid crystal display television 10, lights are always emitted from a light source module K of a backlight to the liquid crystal panel 1 on which the image is displayed.

Therefore, when a moving image is displayed on the display screen G (see FIG. 1A), the luminance of the backlight is kept after the moving image goes away. As a result, the luminance of an area at which the moving image has gone away is kept, and the moving image is blurred.

With respect to the above phenomenon, in the liquid crystal display television 10 shown in FIG. 1, the light source module K is independently controlled for every area of the display screen G, and the backlight of the display screen G is controlled by the control unit 8a for every independent area. Therefore, when a moving image is displayed on the display screen G, as shown in FIG. 12B, if the moving image exists at an area r, the light source module K is controlled to be turned on (“ON” status) or to increase a light quantity, and if the moving image does not exist at the area r, the light source module K is controlled to be turned off (“OFF” status) or to decrease the light quantity.

According to the above described mechanism, an image close to that of the cathode-ray tube television shown in FIG. 12A is achieved, the backlight is turned on or the light quantity is increased at the area on which the moving image exists, and the backlight is turned off or the light quantity is decreased at the area on which the moving image does not exist. Therefore, the backlight follows the moving image, and the blurring of the moving image is suppressed. As a result, the moving image quality is enhanced.

Therefore, a display appliance having an enhanced moving image quality is realized.

In addition, although the light source module K having LEDs (Light Emitting Diode) is disclosed as a light source in the first, second, third, fourth, and fifth embodiments, other components than LED may be used as the light source as long as they work as the light source.

Also, although the display screen G (see FIG. 1A) is evenly divided into areas, the display screen G may be unevenly divided into any size of areas. For example, large areas may be placed on the center of the display screen G (see FIG. 1A), and the nearer to the end portion, the smaller the area. Also, the areas may have different size one another.

In addition, although the liquid crystal display television is disclosed as the liquid crystal display appliance in the first, second, third, fourth, and fifth embodiments, the present invention can be widely applied to an electronics device having a display appliance such as a large-screen display, a personal computer, and a cellular phone, etc.

What is claimed is:

1. A liquid crystal display appliance comprising:
a lighting apparatus comprising:
a light source, and
an light guide plate to diffuse lights from the light source to obtain a surface light source; and
a liquid crystal panel which is placed opposed to the lighting apparatus and includes a liquid crystal layer;
wherein the light guide plate is made by bonding a plurality of transparent light guide members each of which has a different refractive index greater than 1.

2. The liquid crystal display appliance according to claim 1, wherein the light guide plate comprises:
a first transparent light guide member which is provided corresponding to each of a plurality of divided areas;
a second transparent light guide member to connect the first transparent light guide members one another; and
a third transparent light guide member having a refractive index less than that of the first transparent light guide member to connect the first transparent light guide members one another.

3. The liquid crystal display appliance according to claim 1, wherein the light guide plate comprises:
a first transparent light guide member which is provided corresponding to each of a plurality of divided areas; and
a second transparent light guide member having a refractive index less than that of the first transparent light guide member to connect the first transparent light guide members one another.

4. The liquid crystal display appliance according to claim 3, wherein a surface of the first transparent light guide member and a surface of the second transparent light guide member, from which lights are emitted toward the liquid crystal panel, are approximately coplanar, and a third light guide plate is provided on the first transparent light guide member and the second transparent light guide member.

5. The liquid crystal display appliance according to claim 3, wherein a surface of the first transparent light guide member and a surface of the second transparent light guide member, from which lights are emitted toward the liquid crystal panel, are approximately coplanar, and a third transparent light guide member is provided on the first transparent light guide member and the second transparent light guide member via a transparent and adhesive layer.

6. The liquid crystal display appliance according to claim 1, wherein a reflecting member to reflect lights passing through the light guide plate to suppress an irregular luminance is provided on a surface above which the liquid crystal panel is provided, and the surface is opposed to the second transparent light guide member.

7. The liquid crystal display appliance according to claim 1, wherein the light guide plate is divided into a plurality of areas by forming a groove portion, and the groove portion is filled with the second transparent light guide member having a refractive index less than that of the first transparent light guide member

8. The liquid crystal display appliance according to claim 7, wherein a reflecting member to reflect lights passing through the light guide plate to suppress an irregular luminance is provided on a surface above which the liquid crystal panel is provided, and the surface is opposed to the second transparent light guide member.

9. The liquid crystal display appliance according to claim 6, wherein the reflecting member is provided on a surface of the light guide plate, above which the liquid crystal panel is provided.

10. The liquid crystal display appliance according to claim 1, wherein supporting members are provided on a top surface and a bottom surface of the light guide plate to absorb a warpage caused by thermal expansion of the light guide plate and to reinforce the light guide plate.

11. The liquid crystal display appliance according to claim 2, wherein the light source is provided corresponding to each of the areas respectively.

12. The liquid crystal display appliance according to claim 11, further comprises a light dimming controller to control the light source to increase the light quantity at a high luminance area, and to decrease the light quantity at a low luminance area.

13. The liquid crystal display appliance according to claim 11, further comprises a light dimming controller to control the light source to increase a light quantity at an area if a moving image exists at the area, and to decrease the light quantity at the area if the moving image does not exist at the area.
